(19) United States
(12) Patent Application Publication
(10) Pub. No.: US 2021/0094881 A1
(43) Pub. Date: Apr. 1, 2021

(54) POLYCRYSTALLINE DIAMOND CONSTRUCTIONS

(71) Applicant: Element Six (UK) Limited, Oxfordshire (GB)

(72) Inventor: Edwin Stewart EARDLEY, Oxfordshire (GB)

(21) Appl. No.: 17/041,132

(22) PCT Filed: Mar. 25, 2019
(86) PCT No.: PCT/EP2019/057449

§ 371 Date: Sep. 24, 2020

(30) Foreign Application Priority Data
Mar. 26, 2018 (GB) 1804799.3

(51) Int. Cl. C04B 35/528; C04B 35/645; C22C 26/00; C22C 1/05; E21B 10/46

(52) U.S. Cl. CPC C04B 35/528; C04B 35/645; C22C 26/00; C22C 1/05; C04B 2235/783; C04B 2235/427; C04B 2235/85; C04B 2235/785; C04B 2235/786; E21B 10/46

(57) ABSTRACT

A polycrystalline diamond (PCD) construction has a first region of a first grade of PCD material; and a second region of a second grade of PCD material, the first region being at least partially peripherally surrounded by the second region, the first and second regions being bonded to each other by direct inter-growth of diamond grains to form an integral PCD structure and a substrate bonded to the first and/or second region(s) along an interface. The first grade of PCD differs from the second grade in one or more of diamond and metal network compositional ratio, metal elemental composition, or average diamond grain size, the first grade of PCD material having a larger average diamond grain size than the second grade of PCD material, and/or a smaller volume percentage of residual catalyst and/or binder in interstitial spaces between interbonded diamond grains than the PCD material of the second region.

### FIELD

This disclosure relates to polycrystalline diamond (PCD) constructions, a method for making same and tools comprising same, particularly but not exclusively for use in rock degradation or drilling, or for boring into the earth.

Background

PCD material comprises a mass of substantially inter-grown diamond grains and interstices between the diamond grains. PCD material may be made by subjecting an aggregated mass of diamond grains to an ultra-high pressure and temperature in the presence of a sintering aid such as cobalt, which may promote the inter-growth of the diamond grains. The sintering aid may also be referred to as a catalyst material for diamond. Interstices within the PCD material may be wholly or partially filled with residual catalyst material after the material is formed by a sintering process. PCD material may be integrally formed on and bonded to a cobalt-cemented tungsten carbide substrate, which may provide a source of cobalt catalyst material for sintering the PCD material. Tool inserts comprising PCD material are widely used in drill bits for boring into the earth in the oil and gas drilling industry.

Although PCD material is extremely abrasion resistant, spall cracks may propagate rapidly across the PCD material in use which may lead to the loss of large portions of the cutter surface and exposure of the carbide substrate. If the spall is sufficiently large it may also prevent the rotation and/or reuse of the cutter within the drill bit necessitating its replacement. There is therefore a need for PCD tool inserts that have enhanced fracture/failure resistance.

### SUMMARY

Viewed from a first aspect there is provided a polycrystalline diamond (PCD) construction comprising:
a first region comprising a first grade of PCD material; and
a second region comprising a second grade of PCD material, the first region being at least partially peripherally surrounded by the second region, the first and second regions being bonded to each other by direct inter-growth of diamond grains to form an integral PCD structure; wherein:
   the first grade of PCD material differs from the second grade of PCD material in one or more of diamond and metal network compositional ratio, metal elemental composition, or average diamond grain size, the first grade of PCD material having a larger average diamond grain size than the average diamond grain size of the second grade of PCD material, and/or a smaller volume percentage of residual catalyst and/or binder in interstitial spaces between interbonded diamond grains than the in the PCD material of the second region.

Viewed from a second aspect there is provided a method of making a PCD construction, the method comprising providing a first plurality of aggregate masses comprising diamond grains having a first average grain size, at least one second aggregate mass comprising diamond grains having a second average size smaller than said first average grain size; arranging the first and second aggregate masses in an configuration such that the first aggregate mass being at least partially peripherally surrounded by the second aggregate mass;
and treating the pre-sinter assembly in the presence of a catalyst material for diamond at an ultra-high pressure and high temperature at which diamond is more thermodynamically stable than graphite to sinter together the diamond grains and form an integral PCD construction comprising:
a first region comprising a first grade of PCD material; and
a second region comprising a second grade of PCD material, the first region being at least partially peripherally surrounded by the second region, the first and second regions being bonded to each other by direct inter- growth of diamond grains to form an integral PCD structure; wherein:
the first grade of PCD material differs from the second grade of PCD material in one or more of diamond and metal network compositional ratio, metal elemental composition, or average diamond grain size, the first grade of PCD material having a larger average diamond grain size than the average diamond grain size of the second grade of PCD material, and/or a smaller volume percentage of residual catalyst and/or binder in interstitial spaces between interbonded diamond grains than the in the PCD material of the second region

A PCD element comprising a PCD structure bonded to a cemented carbide support body may be provided. A tool comprising a PCD element may also be provided. The tool may be a drill bit or a component of a drill bit for boring into the earth, or a pick or an anvil for degrading or breaking hard material such as asphalt or rock.

### BRIEF DESCRIPTION OF THE DRAWINGS

Examples of PCD constructions will now be described with reference to the accompanying drawings, in which:

FIG. 1 is a schematic perspective view of an example PCD cutter element for a drill bit for boring into the earth;

FIG. 2 is a schematic cross-section of a conventional portion of a PCD micro-structure with interstices between the inter-bonded diamond grains filled with a non-diamond phase material; and

FIG. 3 is a schematic partially cut-away perspective view from above of an example PCD cutter element.

The same references refer to the same general features in all the drawings.

### DESCRIPTION

As used herein, polycrystalline diamond (PCD) is a super-hard material comprising a mass of diamond grains, a substantial portion of which are directly inter-bonded (intergrown) with each other and in which the content of diamond is at least about 80 volume percent of the material.

As used herein, “interstices” or “interstitial regions” are regions between the interbonded diamond grains in the PCD material. In examples of PCD material, interstices or interstitial regions may be substantially or partially filled with a material other than diamond, or they may be substantially empty. In one example of PCD material, interstices between the diamond gains may be at least partly filled with a binder material comprising a catalyst for diamond. Further examples of PCD material may comprise at least a region from which catalyst material has been removed from the interstices, leaving interstitial voids between the diamond grains.

As used herein, a catalyst material for diamond is a material capable of promoting the direct intergrowth of diamond grains and may also comprise and/or perform the function of a binder material for bonding the diamond grains to one another, and it is therefore termed “catalyst and/or binder”.

As used herein, a PCD grade is a PCD material characterised in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material.

Different PCD grades may have different microstructure and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

The table below shows approximate compositional characteristics and properties of three example PCD grades referred to as PCD grades I, II and III. All of the PCD grades in the table below comprise interstitial regions filled with material comprising cobalt metal, which is an example of catalyst material for diamond.

| | PCD grade I | PCD grade II | PCD grade III |
|---|---|---|---|
| Mean grain size, microns | 7 | 11 | 16 |
| Catalyst content, vol. % | 11.5 | 9.0 | 7.5 |
| TRS, MPa | 1,880 | 1,630 | 1,220 |
| K₁C, MPa · m^{1/2} | 10.7 | 9.0 | 9.1 |
| E, GPa | 975 | 1,020 | 1,035 |
| CTE, 10⁻⁶ mm/° C. | 4.4 | 4.0 | 3.7 |

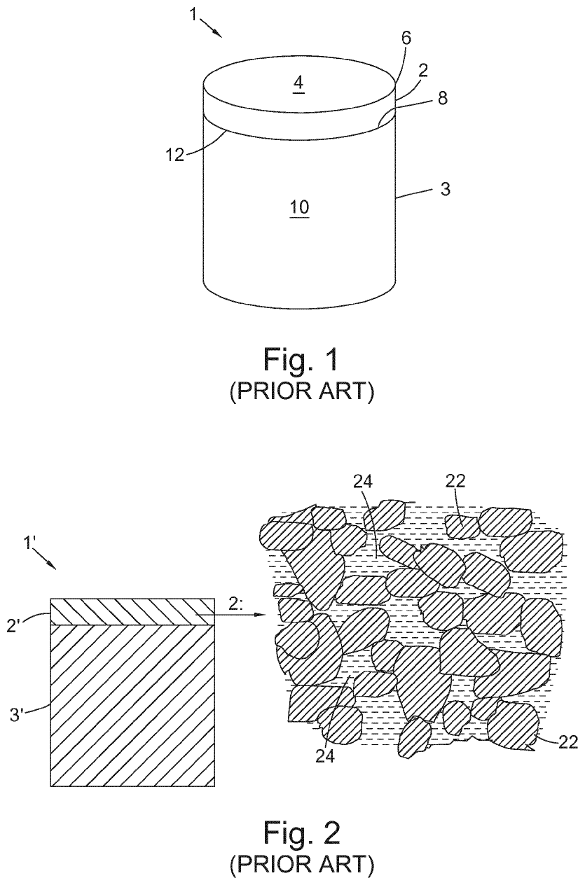

With reference to FIG. 1, a conventional PCD construction 1 is shown which is suitable for use as a cutter insert for a drill bit (not shown) for boring into the earth. The construction 1 comprises a PCD structure 2 bonded or otherwise joined to a support body or substrate 3 along an interface 8 which may be substantially planar or non-planar.

The PCD structure 2 comprises a body of super hard material such as PCD material, which may conventionally comprise one or more PCD grades. The substrate 3 may be formed of a hard material such as a cemented carbide material and may be, for example, cemented tungsten carbide, cemented tantalum carbide, cemented titanium carbide, cemented molybdenum carbide or mixtures thereof. The binder metal for such carbides may be, for example, nickel, cobalt, iron or an alloy containing one or more of these metals. Typically, this binder will be present in an amount of 10 to 20 mass %, but this may be as low as 6 mass % or less. Some of the binder metal may infiltrate the body of polycrystalline diamond material 2 during formation of the compact

The construction 1 may form a cutting element which may be mounted in use into a bit body such as a drag bit body (not shown). The exposed top surface 4 of the super hard material 2 opposite the substrate 3 forms the working surface, which is the surface which, along with its edge 6, performs the cutting in use.

The substrate 3 may be, for example, generally cylindrical and has a peripheral surface 10 and a peripheral top edge 8.

The PCD element 1 may also be substantially cylindrical in shape, with the PCD structure 2 located at a working end and defining the working surface 4.

The exposed surface 4 of the cutter element 1 comprises the working surface 4 which also acts as a rake face in use. A chamfer may extend between the working surface 4 and the cutting edge 6, and at least a part of a flank or barrel of the cutter, the cutting edge 6 being defined by the edge of the chamfer and the flank.

The working surface or “rake face” 4 of the cutter is the surface or surfaces over which the chips of material being cut flow when the cutter is used to cut material from a body, the rake face 4 directing the flow of newly formed chips. This face 4 is commonly referred to as the top face or working surface of the cutter. As used herein, “chips” are the pieces of a body removed from the work surface of the body by the cutter in use.

As used herein, the “flank” of the cutter is the surface or surfaces of the cutter that passes over the surface produced on the body of material being cut by the cutter and is commonly referred to as the side or barrel of the cutter. The flank may provide a clearance from the body and may comprise more than one flank face.

As used herein, a “cutting edge” 6 is intended to perform cutting of a body in use.

As used herein, a “wear scar” is a surface of a cutter formed in use by the removal of a volume of cutter material due to wear of the cutter. A flank face may comprise a wear scar. As a cutter wears in use, material may be progressively removed from proximate the cutting edge, thereby continually redefining the position and shape of the cutting edge, rake face and flank as the wear scar forms. As used herein, it is understood that the term “cutting edge” refers to the actual cutting edge, defined functionally as above, at any particular stage or at more than one stage of the cutter wear progression up to failure of the cutter, including but not limited to the cutter in a substantially unworn or unused state.

As used herein, the term “stress state” refers to a compressive, unstressed or tensile stress state. Compressive and tensile stress states are understood to be opposite stress states from each other. In a cylindrical geometrical system, the stress states may be axial, radial or circumferential, or a net stress state.

As shown in FIG. 2, during formation of the polycrystalline composite construction 1, the interstices 24 between the diamond grains 22 forming the PCD material 2, may be at least partly filled with a non-super hard phase material. This non-super hard phase material, also known as a filler material may comprise residual catalyst/binder material, for example cobalt, nickel or iron and may also, or in place of, include one or more other non-super hard phase additions.

With reference to FIGS. 1 and 2, the substrate 3 may comprise a cemented carbide material, such as tungsten carbide (WC) formed of a mass of grains of a hard material comprising a carbide phase and interstices between the hard grains which are filled with a binder material which constitutes the binder phase.

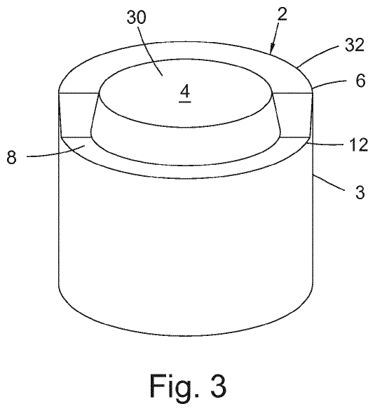

With reference to FIG. 3, an example of a PCD construction comprises a PCD structure 2 integrally joined to a cemented carbide support body 3. The PCD structure 2 comprises a first region 30 at least partially peripherally surrounded by a second region 32.

In the example shown in FIG. 3, the first region 30 extends in a plane substantially parallel with the plane through the longitudinal axis of the construction and extends to and forms part of the working surface 4 of the PCD structure 2. In some examples, the first region 30 may extend to the interface 8 with the substrate 3 or be spaced from the interface 8. Furthermore, the first region 30 in some examples is spaced from the peripheral side edge of the construction by the second region 32 of PCD material.

The material of the first region 30 differs in one or more of diamond and metal network compositional ratio, or metal elemental composition, diamond grain size distribution, or residual stress state to the material of the second region 32. In some examples, the average size of the diamond grains in the PCD material of the first region 30 is greater than the average grain size of the diamond grains in the PCD material of the second region 32. In a further example, the volume percentage of residual binder/catalyst material in the interstitial spaces between the interbonded diamond grains in the PCD material of the first region 30 is less than the volume percentage of residual binder/catalyst material in the interstitial spaces between the interbonded diamond grains in the PCD material of the second region 32.

The PCD material for any one or more of the first and second regions 30, 32 may be selected to achieve the desired configuration. For example, variations in mechanical properties such as density, elastic modulus, hardness and coefficient of thermal expansion (CTE) may be selected for this purpose. Such variations may be achieved by means of variations in content of diamond grains, content and type of filler material, size distribution or average grain size of the PCD grains.

In some examples, such as that shown in FIG. 3, the PCD construction 2 is substantially cylindrical, the first region 30 being substantially coaxial with the second region 32 and radially encircled by the second region 32. In some examples, the second region 32 is discontinuous around the first region 30.

An example method for making a PCD construction is now described.

A support body in the form of a substrate 3 comprising cemented carbide in which the cement or binder material comprises a catalyst material for diamond, such as cobalt, may be provided. The support body 3 may have a non-planar end 12 or a substantially planar proximate end on which the PCD structure 2 is to be formed. A non-planar shape of the end 8 may be configured to reduce undesirable residual stress between the PCD structure 2 and the support body 3. In one version, the aggregate masses of diamond grains to form the first and second regions respectively may comprise substantially loose diamond grains, or diamond grains held together by a binder material. The aggregate masses may be in the form of granules, discs, wafers or sheets, and may contain catalyst material for diamond and / or additives for reducing abnormal diamond grain growth, for example, or the aggregated mass may be substantially free of catalyst material or additives. In one version, the mean diamond grain size for forming the second region 32 may be in the range from about 0.1 micron to about 15 microns, and the mean diamond grain size for forming the first region 30 may be in the range from about 10 microns to about 40 microns. In one version, cup may be provided for use in assembling pre-composite structure, the aggregate masses may be assembled onto a cemented carbide support body in the desired configuration in the cup to create the segments shown in FIG. 3.

The pre-sinter assembly for making an example PCD construction therefore may comprise a support body to form the substrate 3, a region comprising diamond grains to form the second region 32 may then packed against a non- planar end of the support body, and the diamond grains to form the first region may be provided either in pre-sintered form, or in the form of discs or wafers or loose grains to form the first region 30. In some versions, the aggregate masses may be in the form of loose diamond grains or granules.

The pre-sinter assembly may then be placed into a capsule for an ultra-high pressure press and subjected to an ultra-high pressure of at least about 5.5 GPa and a high temperature of at least about 1,300 degrees centigrade to sinter the diamond grains and form a PCD element comprising a PCD structure integrally joined to the support body. In one version of the method, when the pre-sinter assembly is treated at the ultra-high pressure and high temperature, the binder material within the support body melts and infiltrates the regions of diamond grains. The presence of the molten catalyst material from the support body is likely to promote the sintering of the diamond grains by intergrowth with each other to form an integral, segmented PCD structure.

During sintering, the first and second regions 30, 32 are bonded together by direct diamond-to-diamond intergrowth to form an integral, solid body of PCD material.

As the regions 30, 32 may comprise different respective PCD grades as a result of the different average diamond grain sizes of the regions, different amounts of catalyst material may infiltrate into the regions due to the different sizes of spaces between the diamond grains. The corresponding PCD regions 30, 32 may thus comprise different amounts of residual catalyst/binder material for diamond. The content of the catalyst material in terms of volume percent within the second region 32 may be greater than that within the first region 30.

In one example, the first region comprises diamond grains having mean size greater than the mean size of the diamond grains of the second region 32.

The PCD constructions described with reference to FIG. 3 may be processed by grinding to modify its shape to form a PCD construction substantially as described with reference to FIG. 1. Catalyst material may be removed from a region of the PCD structure adjacent the working surface 4 or the side surface or both the working surface 4 and the side surface. This may be achieved by treating the PCD structure 2 with acid to leach out catalyst material from between the diamond grains, or by other methods such as electrochemical methods. A thermally stable region, which may be substantially porous, extending a depth of at least about 50 microns or at least about 100 microns from a surface of the PCD structure 2, may thus be provided. In one example, the substantially porous region may comprise at most 2 weight percent of catalyst material.

The PCD construction 1 may be substantially cylindrical and have a substantially planar working surface (as shown in FIGS. 1 to 3), or a generally domed, pointed, rounded conical or frusto-conical working surface. The PCD element may be for a rotary shear (or drag) bit for boring into the earth, for a percussion drill bit or for a pick for mining or asphalt degradation.

PCD elements as described herein may have enhanced resistance to fracture.

Whilst not wishing to be bound by a particular theory, it is believed that the example PCD constructions may be manufactured with first and second regions of two distinct PCD feeds with the intent that any crack that is initiated may be terminated by intersecting a PCD feed with different properties, or be directed by the first region 30 and/or second region 32 due to residual stress differences between the regions to avoid a catastrophic spall. It may be possible to contain/control the different generated residual stresses within the regions by using PCD with different properties, generating tension and compression as desired, and inhibit these stresses from extending out to the peripheral outer surface of the construction thereby enabling management of crack initiation and propagation during use of the construction.

1. A polycrystalline diamond (PCD) construction comprising:
a first region comprising a first grade of PCD material; and
a second region comprising a second grade of PCD material, the first region being at least partially peripherally surrounded by the second region, the first and second regions being bonded to each other by direct inter-growth of diamond grains to form an integral PCD structure; wherein:
the first grade of PCD material differs from the second grade of PCD material in one or more of diamond and metal network compositional ratio, metal elemental composition, or average diamond grain size, the first grade of PCD material having a larger average diamond grain size than the average diamond grain size of the second grade of PCD material, and/or a smaller volume percentage of residual catalyst and/or binder in interstitial spaces between interbonded diamond grains than the in the PCD material of the second region; and a substrate bonded to the first and/or second region(s) along an interface.

2. The PCD construction of claim 1, wherein the first region forms part of a working surface of the PCD construction.

3. The PCD construction of claim 1, wherein the first region is spaced from a working surface and/or a side surface of the PCD construction by the second region of PCD material.

4. The PCD construction of claim 1, comprising a thermally stable region extending a depth of at least 50 microns from a surface of the PCD structure; the thermally stable region comprising at most 2 weight percent of catalyst material for diamond.

5. The PCD construction of claim 1, wherein the PCD construction is substantially cylindrical, the first region being coaxial with the second region and radially encircled by the second region.

6. The PCD construction of claim 5, wherein the second region is discontinuous around the first region.

7. A method of making a PCD construction, the method comprising providing a first plurality of aggregate masses comprising diamond grains having a first average grain size, at least one second aggregate mass comprising diamond grains having a second average size smaller than said first average grain size; arranging the first and second aggregate masses in an configuration such that the first aggregate mass being at least partially peripherally surrounded by the second aggregate mass;
and treating the pre-sinter assembly in the presence of a catalyst material for diamond at an ultra-high pressure and high temperature at which diamond is more thermodynamically stable than graphite to sinter together the diamond grains and form an integral PCD construction comprising:
a first region comprising a first grade of PCD material; and
a second region comprising a second grade of PCD material, the first region being at least partially peripherally surrounded by the second region, the first and second regions being bonded to each other by direct inter-growth of diamond grains to form an integral PCD structure; wherein:
the first grade of PCD material differs from the second grade of PCD material in one or more of diamond and metal network compositional ratio, metal elemental composition, or average diamond grain size, the first grade of PCD material having a larger average diamond grain size than the average diamond grain size of the second grade of PCD material, and/or a smaller volume percentage of residual catalyst and/or binder in interstitial spaces between interbonded diamond grains than the in the PCD material of the second region.

8. A method as claimed in claim 7, in which the aggregate masses comprise diamond grains held together by a binder material.

9. A method as claimed in claim 7, in which the second average grain size is in the range from 0.1 micron to 15 microns, and the first average grain size is in the range from 10 microns to 40 microns.

10. A PCD element for a rotary shear bit for boring into the earth, for a percussion drill bit or for a pick for mining or asphalt degradation, comprising a PCD construction as claimed in claim 1, bonded to a cemented carbide support body along an interface.

11. A drill bit or a component of a drill bit for boring into the earth, comprising the PCD construction of claim 1.
